(19) United States
(12) Patent Application Publication
(10) Pub. No.: US 2010/0092210 A1
(43) Pub. Date: Apr. 15, 2010

(54) IMAGE FORMING APPARATUS

(76) Inventors: Jun Kawai, Saitama-shi (JP); Hiroaki Nieda, Saitama-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/574,301

(22) Filed: Oct. 6, 2009

(30) Foreign Application Priority Data
Oct. 10, 2008 (JP) 2008-264301

(51) Int. Cl. G03G 21/18

(52) U.S. Cl. 399/114

(57) ABSTRACT

An image forming apparatus includes: an apparatus body that includes an image forming unit forming an image; a switching mechanism that switches a state of members between a contacting state and a non-contacting state, the members related to image formation by the image forming unit in the apparatus body; a covering unit that is supported in the apparatus body so as to be freely opened and closed, and that covers a part of the apparatus body when being closed; and a connection unit that is provided to the covering unit, that is not connected to the switching mechanism when the covering unit is opened while being connected to the switching member when the covering unit is closed, and that causes the switching mechanism to operate in conjunction with an operation by an operator any one of to open and to close the covering unit.

### CROSS REFERENCE TO RELATED APPLICATIONS

This application is based on and claims priority under 35 USC §119 from Japanese Patent Application No. 2008-264301 filed Oct. 10, 2008.

### BACKGROUND

1. Technical Field

The present invention relates to an image forming apparatus.

2. Related Art

There has been proposed an image forming apparatus including: at least one device that is provided in the side of an opening portion formed in the apparatus body so as to be freely attachable to and detachable from the apparatus body; and a holding member that is provided so as to be freely opened and closed relative to the opening portion, and that guides and fixes the device at a predetermined position by engaging with the device when the holding member occupies a close position.

### SUMMARY

According to an aspect of the present invention, there is provided an image forming apparatus including: an apparatus body that includes an image forming unit forming an image; a switching mechanism that switches a state of members between a contacting state and a non-contacting state, the members related to image formation by the image forming unit in the apparatus body; a covering unit that is supported in the apparatus body so as to be freely opened and closed, and that covers apart of the apparatus body when being closed; and a connection unit that is provided to the covering unit, that is not connected to the switching mechanism when the covering unit is opened while being connected to the switching member when the covering unit is closed, and that causes the switching mechanism to operate in conjunction with an operation by an operator any one of to open and to close the covering unit.

### BRIEF DESCRIPTION OF THE DRAWINGS

Exemplary embodiment(s) of the present invention will be described in detail based on the following figures, wherein:

FIG. 1 is a diagram showing an entire configuration of an image forming apparatus to which the present invention is applied;

FIGS. 2A and 2B are views for illustrating the belt unit: FIG. 2A is a view illustrating a case where the intermediate transfer belt is in contact with the four photoconductive drums, and FIG. 2B is a view illustrating a case where the intermediate transfer belt is not in contact with the photoconductive drums;

FIG. 3 is a view illustrating a subframe that covers a front side of the belt unit in a first exemplary embodiment;

FIG. 4 is a view illustrating a subframe that covers a front side of the belt unit in a first exemplary embodiment;

FIG. 5 is a substantial plan view illustrating an engagement structure of the apparatus-body-side coupling and the subframe-side coupling, and the like;

FIG. 6 is a perspective view illustrating a lock mechanism that fixes the subframe to the apparatus body;

FIG. 7 is a perspective view illustrating a lock mechanism that fixes the subframe to the apparatus body; and

FIG. 8 is a view illustrating a positional relationship between a subframe-side coupling and a lever of the subframe in a second exemplary embodiment.

### DETAILED DESCRIPTION

Hereinafter, a detailed description will be given of exemplary embodiments of the present invention with reference to attached drawings.

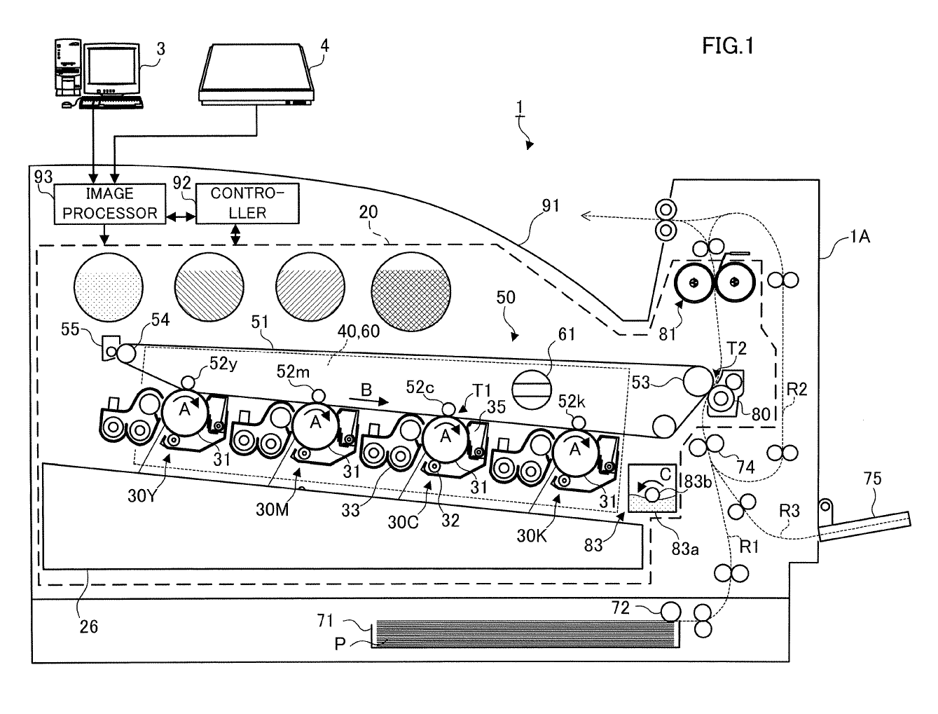

FIG. 1 is a diagram showing an entire configuration of an image forming apparatus to which the present invention is applied. The image forming apparatus 1 shown in FIG. 1 is an electrophotographic digital color printer of a so-called tandem type. Inside a body of the apparatus (apparatus body) 1A, the image forming apparatus 1 includes an image forming processor 20 that performs image formation in accordance with image data of respective colors.

Further, the image forming apparatus 1 includes a controller 92 that controls operations of respective units and devices provided inside the apparatus body 1A. Furthermore, the image forming apparatus 1 includes an image processor 93 that performs an image processing on image data received from, for example, a personal computer (PC) 3, a scanner 4 or the like, and a main memory (not shown in the figure) that is implemented by, for example, a HDD (hard disk drive) in which a processing program, image data and the like are stored.

In the image forming processor 20, four image forming units 30Y, 30M, 30C and 30K (hereinafter, also collectively referred to as “image forming units 30”) are arranged in parallel at regular intervals in a lateral direction of the figure. Each of the image forming units 30 includes a photoconductive drum 31, a charging roll 32, a development device 33, and a drum cleaner 35. The photoconductive drum is an example of an image carrier, and forms an electrostatic latent image while rotating in an arrow A direction. The charging roll 32 charges a surface of the photoconductive drum 31. The development device 33 develops the electrostatic latent image formed on the photoconductive drum 31 with each color toner. The drum cleaner 35 cleans the surface of the photoconductive drum 31 after transfer.

In this configuration, each of the image forming units 30 is provided so as to be replaceable from (attachable to and detachable from) the apparatus body 1A. For example, when the life span of the photoconductive drum 31 is over, the image forming unit 30 is replaced as one unit. It should be noted that, in the present exemplary embodiment, these four image forming units 30Y, 30M, 30C and 30K are taken as an image forming part.

The charging roll 32 is formed of a roll member in which a conductive elastic body layer and a conductive surface layer are stacked on a conductive core bar made of aluminum, stainless steel or the like. The charging roll 32 receives charging bias voltage supplied from a charging power supply (not shown in the figure), and uniformly charges the surface of the photoconductive drum 31 at a predetermined potential while being driven to rotate with respect to the photoconductive drum 31.

The development device 33 holds a two-component developer composed of magnetic carriers and any one of yellow (Y) toner, magenta (M) toner, cyan (C) toner and black (K) toner in each of the image forming units 30, and develops the electrostatic latent image formed on the photoconductive drum 31 with each color toner.

The drum cleaner 35 has a plate member formed of a rubber material such as urethane rubber, and brings the plate member into contact with the surface of the photoconductive drum 31 to remove toner, paper dust and the like attached on the photoconductive drum 31.

Moreover, the image forming processor 20 is provided with a laser exposure device 26 that exposes the photoconductive drums 31 provided in respective image forming units 30. The laser exposure device 26 acquires respective color image data from the image processor 93, and scans and exposes the surface of the photoconductive drum 31 of each of the image forming units 30 with laser light that is light-controlled on the basis of the acquired image data.

Further, the image forming processor 20 is provided with a belt unit 50 as an example of a driven member. Here, the belt unit 50 is attachably and detachably provided to the apparatus body 1A (detachably from the apparatus body 1A toward a front side (a front side of the figure)) in order to make maintenance and the like performable, and in order to make a new belt unit 50 attachable. The belt unit 50 is provided with an intermediate transfer belt 51 as an example of a belt member, primary transfer rolls 52y, 52m, 52c and 52k, a driving roll 53, and an idle roll 54.

Here, the intermediate transfer belt 51 is an endless belt member, and is stretched by at least the idle roll 54 and the driving roll 53. The intermediate transfer belt 51 is circularly moved by the driving roll 53 that is driven by a motor (not shown in the figure) excellent in a constant speed. On the intermediate transfer belt 51, respective color toner images formed on the respective photoconductive drums 31 of the image forming units 30 are superimposingly transferred.

Each of the primary transfer rolls 52y, 52m, 52c and 52k is arranged inside the intermediate transfer belt 51 and is arranged at a position so as to be opposed to each photoconductive drum 31. Each of the primary transfer rolls 52y, 52m, 52c and 52k sequentially transfers (primarily transfers) each color toner image in corresponding one of the image forming units 30 onto the intermediate transfer belt 51 at a primary transfer portion T1 by forming a transfer electric field between each of the primary transfer rolls 52y, 52m, 52c and 52k and corresponding one of the photoconductive drums 31.

Further, the image forming processor 20 includes a secondary transfer roll 80, and a fixing device 81. The secondary transfer roll 80 collectively transfers (secondarily transfers) superimposed toner images that have been transferred onto the intermediate transfer belt 51 of the belt unit 50, onto a sheet P as a recording medium (recording paper) at a secondary transfer portion T2. The fixing device 81 fixes secondarily transferred images onto the sheet P.

Furthermore, the image forming processor 20 includes a recovery container 83 for recovering toner, paper dust and the like that have been removed by a drum cleaner 35 and a belt cleaner 55 (described later), and that have been transported via a transporting path (not shown in the figure). Here, the recovery container 83 is attached to the apparatus body 1A so as to be pulled toward the front side of the apparatus body 1A. Specifically, the recovery container 83 is provided so as to be attachable to and detachable from the apparatus body 1A. For example, when the recovery container 83 is filled with a toner and the like, the recovery container 83 is pulled out by a user, as an example of an operator, or the like, and then a new recovery container 83 is pushed into the apparatus body 1A. It should be noted that the recovery container 83 includes a container body 83a that contains recovered toner and the like, and a transporting member 83b. The transporting member 83b is formed into a spiral shape, and the transporting member 83b rotates in an arrow C direction shown in the figure by receiving drive force from a drive source (not shown in the figure) to transport toner and the like in the container body 83a.

Furthermore, at a rear side (back side) of the apparatus body 1A, the image forming processor 20 is provided with a first driving unit 40 that causes respective photoconductive drums 31 of the image forming units 30 to be driven to rotate. At the rear side of the apparatus body 1A, the image forming processor 20 is further provided with a second driving unit 60 that causes the drive force from the first driving unit 40 not to be transmitted to some of the photoconductive drums 31, while causing the intermediate transfer belt 51 to be separated (retracted) from the some of the photoconductive drums 31.

In the image forming apparatus 1 of the present exemplary embodiment, the image forming processor 20 performs an image forming operation under the control by the controller 92. Specifically, image data inputted from the PC 3, the scanner 4 or the like are subjected to an image processing by the image processor 93, and the resultant data are supplied to the laser exposure device 26. Then, for example, in the image forming unit 30C of cyan (C), the surface of the photoconductive drum 31 that has been uniformly charged by the charging roll 32 is scanned and exposed by the laser exposure device 26 with light-controlled laser light on the basis of the image data from the image processor 93, and thus an electrostatic latent image is formed on the photoconductive drum 31. The formed electrostatic latent image is developed by the development device 33, and a cyan (C) toner image is formed on the photoconductive drum 31.

Similarly to this operation, in the image forming units 30Y, 30M and 30K, yellow (Y), magenta (M) and black (K) toner images are formed, respectively.

Then, the respective color toner images formed in the respective image forming units 30 are electrostatically transferred in sequence, onto the intermediate transfer belt 51 that circularly moves in an arrow B direction in FIG. 1, by the primary transfer rolls 52y, 52m, 52c and 52k to which primary transfer bias is applied from a transfer power supply (not shown in the figure). Thus, superimposed toner images are formed on the intermediate transfer belt 51. Then, the superimposed toner images are transported to the secondary transfer portion T2 in which the secondary transfer roll 80 and the driving roll 53 are provided, in accordance with movement of the intermediate transfer belt 51.

On the other hand, the sheet P as an example of a transfer medium is taken out from a sheet holder 71 by a pick-up roll 72 for paper feeding, and is transported, along a transporting path R1, to a position of registration rolls 74 for regulating a position of the sheet P. The sheet P is transported from the registration rolls 74 toward the secondary transfer portion T2 in synchronization with timing when the superimposed toner images are transported to the secondary transfer portion T2. At the secondary transfer portion T2, by an action of the transfer electric field formed between the secondary transfer roll 80 to which the secondary transfer bias voltage is applied and the driving roll 53, the superimposed toner images are collectively and electrostatically transferred (secondarily transferred) onto the sheet P. It should be noted that, to the secondary transfer portion T2, the sheet P is also transported via a transporting path R2 for duplex printing or a transporting path R3 from a manual sheet holder 75.

Thereafter, the sheet P onto which the superimposed toner images have been electrostatically transferred is peeled from the intermediate transfer belt 51, and is transported to the fixing device 81. Unfixed toner images on the sheet P that has been transported to the fixing device 81 are fixed on the sheet P through a fixing processing with heat and pressure by the fixing device 81. Then the sheet P on which a fixed image has been formed is transported to a sheet stacking unit 91 that is provided at an exit portion of the image forming apparatus 1. On the other hand, toner (transfer remaining toner) and the like attached on the intermediate transfer belt 51 after the secondary transfer are removed by the belt cleaner 55 arranged so as to be in contact with the intermediate transfer belt 51, and the intermediate transfer belt 51 prepares for a next image forming cycle. It should be noted that, the toner and the like removed by the belt cleaner 55 are transported to the recovery container 83 via the unillustrated transporting path, as described above.

Next, a detailed description will be given of the belt unit 50.

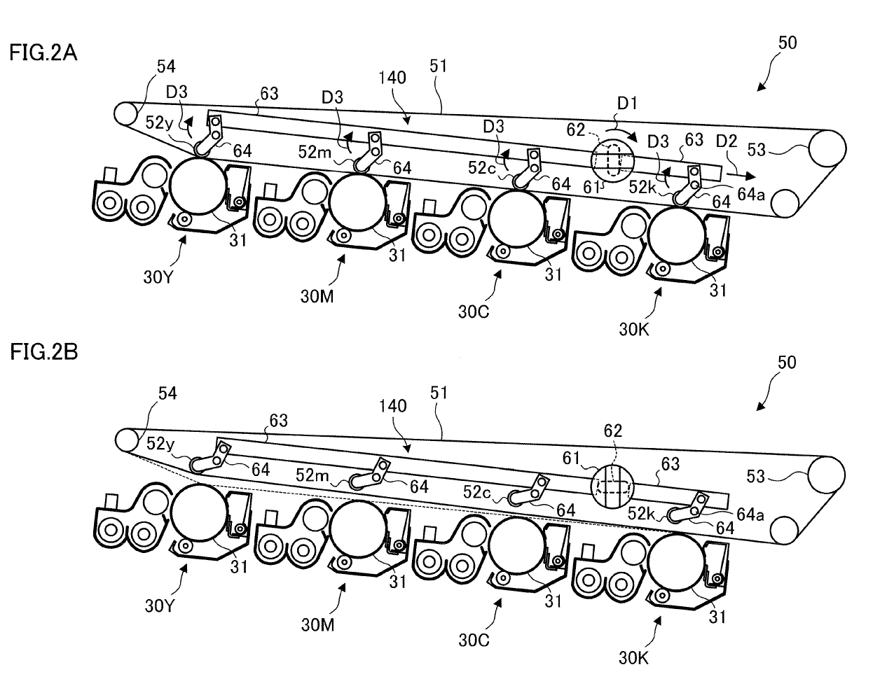

FIGS. 2A and 2B are views for illustrating the belt unit 50. FIG. 2A is a view illustrating a case where the intermediate transfer belt 51 is in contact with the four photoconductive drums 31, and FIG. 2B is a view illustrating a case where the intermediate transfer belt 51 is not in contact with the photoconductive drums 31.

By rotating forward and backward, an apparatus-body-side coupling 61 as an example of a second interlocking unit is capable of switching a contact-separation state of the intermediate transfer belt 51, the primary transfer rolls 52y, 52m, 52c and 52k, and the photoconductive drums 31 (between a contacting state and a non-contacting state (separated state)) as shown in FIGS. 2A and 2B. That is, rotating the apparatus-body-side coupling 61 forward or backward changes the relative positional relationship between each of the primary transfer rolls 52y, 52m, 52c and 52k and the corresponding one of the photoconductive drums 31. Specifically, along with forward rotation or backward rotation of the apparatus-body-side coupling 61, each of the primary transfer rolls 52y, 52m, 52c and 52k is brought into contact with or separated from the corresponding photoconductive drum 31. Thereby, the state of the intermediate transfer belt 51 and the primary transfer rolls 52y, 52m, 52c and 52k is switched between the contacting state and the separated state. Thus, the belt unit 50 includes a mechanism that performs retraction and advance of the apparatus-body-side members related to image formation.

A description will be given of a switching mechanism (changing mechanism) 140 that switches the state of the primary transfer rolls 52y, 52m, 52c and 52k and the photoconductive drums 31 between the contacting state and the non-contacting state as described above. The switching mechanism 140 mainly includes connecting members 64, a coupling member 63, a cam member 62, and the apparatus-body-side coupling 61. More specifically, each of the primary transfer rolls 52y, 52m, 52c and 52k is connected to the coupling member 63 with the corresponding one of the connecting members 64. The coupling member 63 is a longitudinal member and extends from the position of the primary transfer roll 52y to the position of the primary transfer roll 52k.

In the connecting members 64, one end parts (lower end parts) are connected respectively to the primary transfer rolls 52y, 52m, 52c and 52k, while the other end parts (upper end parts) are connected to the coupling member 63 so as to be rotatable forward and backward. Moreover, approximately-middle parts 64a of the respective connecting members 64 are attached to the apparatus body 1A so as to freely rotate forward and backward. Here, the connecting members 64 are each biased by an unillustrated spring in a direction to be switched to the contacting state.

The apparatus-body-side coupling 61 is provided to the apparatus body 1A so as to freely rotate forward and backward. When the apparatus-body-side coupling 61 rotates forward or backward, the cam member 62 rotates in the same direction concomitantly. The position where the cam member 62 rotates forward and backward is located in an unillustrated hollow formed in the coupling member 63. When the cam member 62 rotates forward or backward, the cam member 62 engages with the coupling member 63, and thereby the coupling member 63 moves in a longitudinal direction.

The switching mechanism 140 is configured as described above. Accordingly, as shown in FIG. 2A, when the apparatus-body-side coupling 61 is rotated in an arrow D1 direction (clockwise), which is a forward or backward direction, in a state where the primary transfer rolls 52y, 52m, 52c and 52k and the photoconductive drums 31 are in contact, the coupling member 63 moves in an arrow D2 direction (to the right) by the action of the apparatus-body-side coupling 61 and the cam member 62. Along with this move of the coupling member 63, each of the connecting members 64 rotates in an arrow D3 direction (clockwise), and changes its orientation. Thereby, the primary transfer rolls 52y, 52m, 52c and 52k are separated from the photoconductive drums 31, and are thus in the non-contacting state. Consequently, the intermediate transfer belt 51 is separated from the primary transfer rolls 52y, 52m, 52c and 52k and the photoconductive drums 31 (see FIG. 2B). It should be noted that switching from the non-contacting state to the contacting state is performed by operations such as rotation in the opposite direction from that for switching from the contacting state to the non-contacting state. Thus, a description thereof is omitted here.

### First Exemplary Embodiment

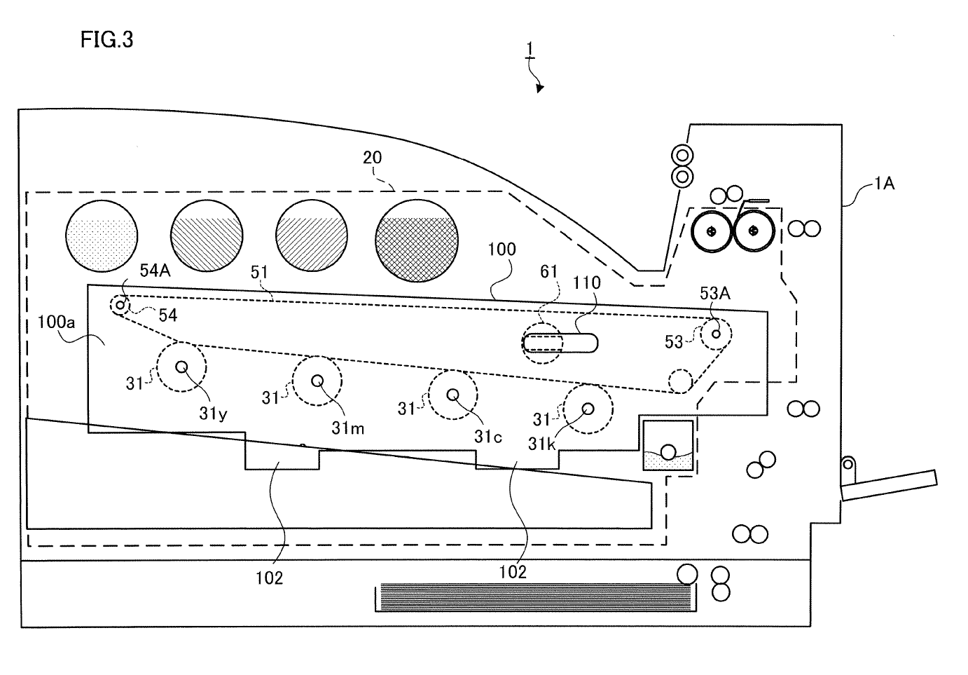

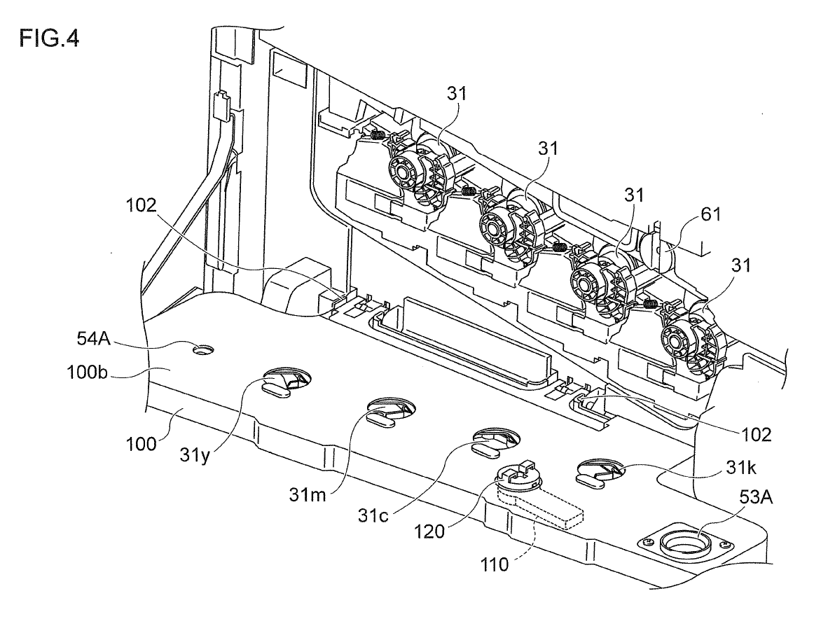

FIG. 3 and FIG. 4 are views illustrating a subframe 100 that covers a front side (near side) of the belt unit 50 in a first exemplary embodiment. FIG. 3 is a view corresponding to FIG. 1 and illustrating a state where the subframe 100 is closed. FIG. 4 is a perspective view illustrating a state where the subframe 100 is opened.

As shown in FIG. 3, the subframe 100, as an example of a covering unit, is attached to the apparatus body 1A with hinges 102, as examples of supporters, so as to freely rotate forward and backward. The hinges 102 are provided on a lower side of the subframe 100. When an unillustrated exterior member is attached to the apparatus body 1A, the subframe 100 becomes invisible from the outside of the apparatus and thus hidden.

The subframe 100 includes holders 31y, 31m, 31c and 31k that respectively hold one end parts (front-side end parts) of the photoconductive drums 31 of the four image forming units 30Y, 30M, 30C and 30K. Specifically, the other end parts (rear-side end parts) of the photoconductive drums 31 are held by an unillustrated frame, while the front-side end parts of the photoconductive drums 31 are held by the holders 31y, 31m, 31c and 31k of the subframe 100.

The subframe 100 further includes holders 53A and 54A that respectively hold one end parts of the driving roll 53 and the idle roll 54. Specifically, rear-side end parts of the driving roll 53 and the idle roll 54 are held by the unillustrated frame, while front-side end parts thereof are held respectively by the holders 53A and 54A of the subframe 100.

Thus, the image forming processor 20 of the present exemplary embodiment employs a configuration in which the four photoconductive drums 31, the driving roll 53 and the idle roll 54 are each held at both ends thereof.

The subframe 100 also includes a lever 110 as an example of an operation unit which a user uses for forward and backward rotation operations when opening and closing the subframe 100. The lever 110 is provided at a position of an outer surface (front-side surface) 100a of the subframe 100. The lever 110 is provided on an upper side of the subframe 100, that is, spaced from the hinges 102. The lever 110 is attached to the subframe 100 so as to be rotatable forward and backward by an angle of, for example, 90 degrees relative to the subframe 100.

As shown in FIG. 4, the subframe 100 includes, on the apparatus body 1A side, a subframe-side coupling 120 that is rotatable forward and backward. The subframe-side coupling 120 shares a common rotational axis with the lever 110. Accordingly, when the lever 110 rotates forward or backward, the subframe-side coupling 120 rotates by the same degrees in the same direction as the lever 110 does. The subframe-side coupling 120 is an example of a connection unit and a first interlocking unit.

More specifically, the subframe-side coupling 120 is provided in a position corresponding to the apparatus-body-side coupling 61. Accordingly, the subframe-side coupling 120 is separated from the apparatus-body-side coupling 61 when the subframe 100 is opened (see FIG. 4), while being engaged with the apparatus-body-side coupling 61 when the subframe 100 is closed (see FIG. 3).

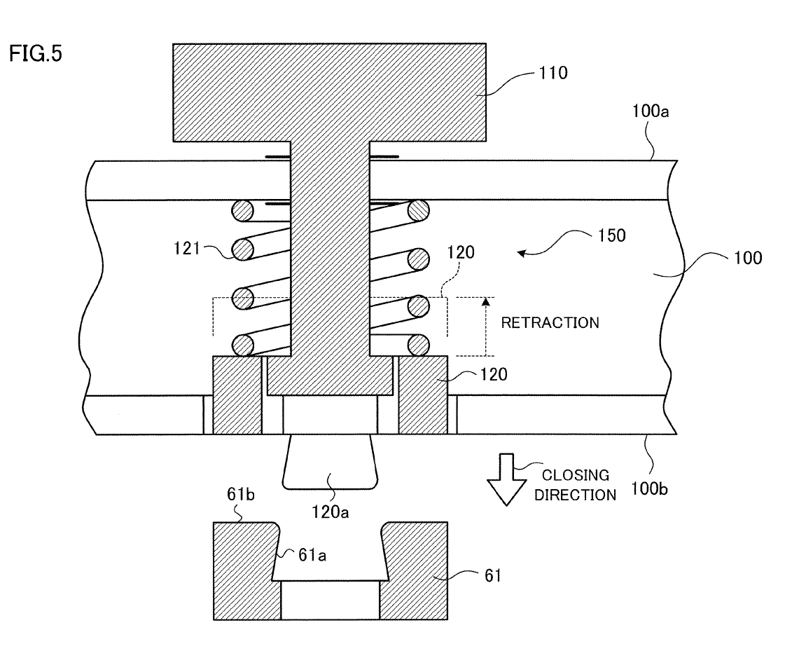

FIG. 5 is a substantial plan view illustrating an engagement structure of the apparatus-body-side coupling 61 and the subframe-side coupling 120, and the like.

As shown in FIG. 5, the apparatus-body-side coupling 61 includes a groove 61a, as an example of an engagement portion, linearly extending in one direction. Moreover, the subframe-side coupling 120 includes a convex (rib) 120a linearly extending in one direction so as to correspond to the groove 61a of the apparatus-body-side coupling 61.

Here, a user may see and touch, by hand, the apparatus-body-side coupling 61 when the subframe 100 is opened. However, since the groove 61a is formed in the apparatus-body-side coupling 61 as described above, it is difficult for the user to easily turn the apparatus-body-side coupling 61 by hand.

Assume that the groove 61a of the apparatus-body-side coupling 61 and the convex 120a of the subframe-side coupling 120 extend in the same direction as shown in FIG. 5. When the subframe 100 is closed in this state, the convex 120a of the subframe-side coupling 120 is engaged with the groove 61a of the apparatus-body-side coupling 61. Specifically, the convex 120a of the subframe-side coupling 120 enters the groove 61a of the apparatus-body-side coupling 61, and is thereby engaged with the groove 61a of the apparatus-body-side coupling 61. Then, when the user turns the lever 110 forward or backward, the subframe-side coupling 120 rotates and concomitantly the apparatus-body-side coupling 61 rotates. Thus, by forward and backward rotation operations of the lever 110 by the user, the state of the primary transfer rolls 52y, 52m, 52c and 52k and the photoconductive drums 31 is switched between the contacting state (see FIG. 2A) and the non-contacting state (see FIG. 2B).

Here, assume that the groove 61a of the apparatus-body-side coupling 61 and the convex 120a of the subframe-side coupling 120 do not extend in the same direction. When the subframe 100 is closed in this state, the convex 120a of the subframe-side coupling 120 is not allowed to enter the groove 61a of the apparatus-body-side coupling 61. To handle such a situation, the subframe 100 includes a retraction mechanism 150 that retracts the subframe-side coupling 120. A description will be given of the retraction mechanism 150.

As shown in FIG. 5, the subframe-side coupling 120 is biased by a compression coil spring 121 in the direction toward the apparatus body side. Accordingly, if the convex 120a of the subframe-side coupling 120 is not engaged with the groove 61a of the apparatus-body-side coupling 61, a tip end of the convex 120a of the subframe-side coupling 120 bumps into an outer surface 61b of the apparatus-body-side coupling 61. The subframe-side coupling 120 in turn moves in the direction toward the lever 110, against biasing force by the compression coil spring 121, and is thus retracted (see broken lines in FIG. 5).

When the convex 120a of the subframe-side coupling 120 is separated from and engaged with the groove 61a of the apparatus-body-side coupling 61, the direction in which the convex 120a of the subframe-side coupling 120 extends is the vertical direction of the apparatus body 1A. In other words, the direction in which the convex 120a extends is not parallel with the forward and backward rotational axis of the subframe 100 (rotational axis of the hinges 102), but is a direction toward the rotational axis or a direction away from the rotational axis (see FIG. 4).

Accordingly, even if there is some backlash between the subframe 100 and the apparatus body 1A, the convex 120a of the subframe-side coupling 120 and the groove 61a of the apparatus-body-side coupling 61 are easily engaged with each other when the opened subframe 100 is closed.

The groove 61a of the apparatus-body-side coupling 61 is a so-called dovetail groove having a groove bottom larger than its opening (a groove having a trapezoidal cross section). Moreover, the convex 120a of the subframe-side coupling 120 has such a shape that its base is narrower than its tip end. Accordingly, if the lever 110 is operated to rotate forward or backward in a state where only the tip end, not up to the base, of the convex 120a of the subframe-side coupling 120 is in the groove 61a of the apparatus-body-side coupling 61, the convex 120a of the subframe-side coupling 120 is drawn into the groove 61a of the apparatus-body-side coupling 61. With this function of assisting the operation by the user to close the subframe 100, the user may close the subframe 100 more easily and surely.

The corners of the groove 61a of the apparatus-body-side coupling 61 and the convex 120a of the subframe-side coupling 120 are chamfered or rounded into R-shape. This further facilitates the engagement of the convex 120a of the subframe-side coupling 120 and the groove 61a of the apparatus-body-side coupling 61.

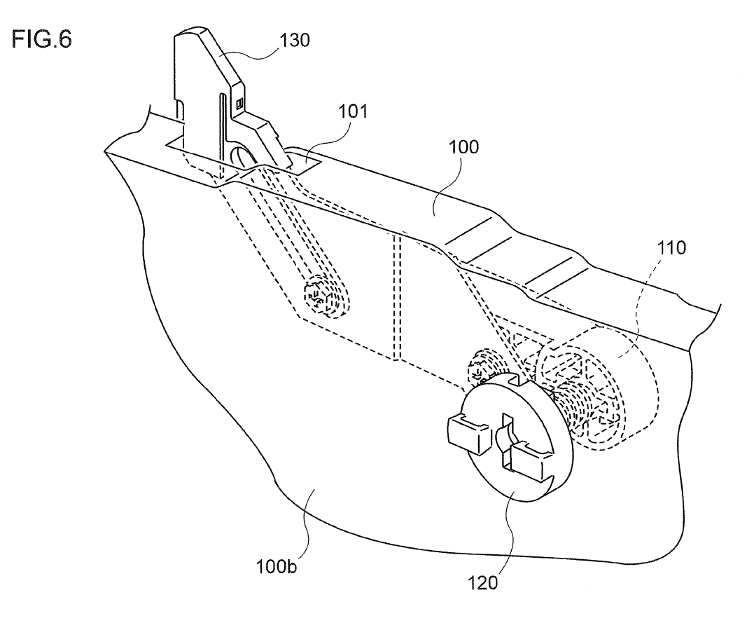

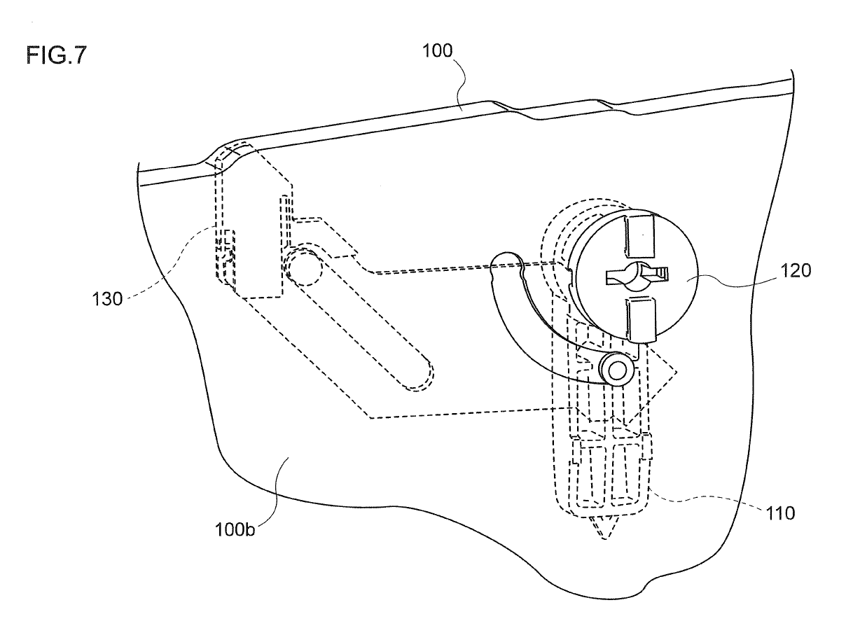

FIG. 6 and FIG. 7 are perspective views illustrating a lock mechanism (fixing mechanism) for locking the subframe 100 to the apparatus body 1A. FIG. 6 and FIG. 7 show the subframe 100 seen from an inner surface (rear-side surface) 100b. FIG. 6 shows a locked state while FIG. 7 shows an unlocked state.

As shown in FIG. 6 and FIG. 7, the subframe 100 includes a lock member 130 that operates in conjunction with a forward or backward rotation of the lever 110. The lock member 130 is provided in the subframe 100 so as to be capable of partially protruding from a cutout 101 formed in the subframe 100.

As shown in FIG. 6, when the lever 110 is operated to rotate forward or backward to cause the lock member 130 to protrude from the cutout 101 of the subframe 100 in a state where the subframe 100 is closed, the lock member 130 comes to be engaged with the apparatus body 1A, and thereby the subframe 100 is locked to the apparatus body 1A. When the lever 110 is operated to rotate forward or backward to cause the lock member 130 not to protrude from the cutout 101 of the subframe 100 as shown in FIG. 7 in a state where the lock member 130 protrudes from the cutout 101 of the subframe 100 and hence the subframe 100 is locked to the apparatus body 1A, the engagement of the lock member 130 with the apparatus body 1A is released. Thereby, the subframe 100 and the apparatus body 1A are unlocked.

As described above, the image forming apparatus 1 of the present exemplary embodiment includes the changing mechanism that is provided to the apparatus body 1A and that changes relative positions of the apparatus-body-1A-side members related to image formation (see FIGS. 2A and 2B). Moreover, the image forming apparatus 1 includes the subframe 100 that is supported in the apparatus body 1A so as to be freely opened and closed (see FIG. 3 and FIG. 4). When being closed, the subframe 100 holds the apparatus-body-1A-side members related to image formation. When being opened, the subframe 100 makes accessible to at least some of the apparatus-body-1A-side members related to image formation. Furthermore, the image forming apparatus 1 includes the lock mechanism that is provided to the subframe 100 and that causes the closed subframe 100 to be engaged with and thereby locked to the apparatus body 1A (see FIG. 6 and FIG. 7). When the user operates the lever 110, provided to the subframe 100, to rotate forward or backward, the changing mechanism and the lock mechanism operate in conjunction with the rotation.

Specifically, when the lever 110 is operated to rotate forward or backward, the state of the primary transfer rolls 52y, 52m, 52c and 52k and the photoconductive drums 31 is switched between the contacting state and the non-contacting state (see FIGS. 2A and 2B) and the state of the subframe 100 and the apparatus body 1A is switched between the locked state and the unlocked state (see FIG. 6 and FIG. 7). Accordingly, all of various operations associated with the operation for a user to open and close the subframe 100 are completed only by the operation of rotating the lever 110 forward and backward. More specifically, in a case of using a general image forming apparatus, the contacting state of internal components is sometimes changed to the non-contacting state by operating a lever after opening a cover member, in order to exchange the internal components or remove a sheet. In such a case, the state of the internal components needs to be changed back to the contacting state by operating the lever again when the cover member is closed. Such operations of the lever required for opening and closing of the cover member are troublesome for the user. Moreover, if the user forgets to put the lever back when closing the cover member, this may cause malfunction of the apparatus, and the like. In the present exemplary embodiment, a structure for preventing such a situation is employed as described above.

If the relationship between the state (the contacting state or the non-contacting state) of the changing mechanism of the apparatus body 1A side and the position of the lever 110 of the subframe 100 is not appropriate, the changing mechanism does not operate in conjunction with a forward or backward rotation operation of the lever 110 (see FIG. 4). This prevents a wrong operation by a user when the user closes the subframe 100.

In addition, in the image forming apparatus 1 according to the present exemplary embodiment, the convex 120a is formed in the subframe-side coupling 120, and the groove 61a is formed in the apparatus-body-side coupling 61. Thus, the image forming apparatus 1 employs such a configuration that the lever 110 and the changing mechanism operate together by engaging the convex 120a and the groove 61a with each other in a state where the subframe 100 is closed (see FIG. 5). When the convex 120a of the subframe-side coupling 120 is to be engaged with the groove 61a of the apparatus-body-side coupling 61, the apparatus-body-side coupling 61 stands ready in such an orientation that the groove 61a extends vertically. Thereby, the subframe 100 is prevented from being influenced by a vertical backlash, if any.

It should be noted that forming the groove 61a in the apparatus-body-side coupling 61 prevents the user from rotating the apparatus-body-side coupling 61 by hand while the subframe 100 is opened.

Moreover, the subframe-side coupling 120 includes the retraction mechanism 150 that makes the subframe-side coupling 120 movable in the thickness direction of the subframe 100 (see FIG. 5). With the retraction mechanism 150, if the relationship between the state of the changing mechanism of the apparatus body 1A side and the position of the lever 110 of the subframe 100 is not appropriate, the subframe-side coupling 120 is retracted. Thereby, the subframe-side coupling 120 is prevented from being damaged due to interference with the apparatus-body-side coupling 61.

The present exemplary embodiment employs the mechanism that switches the state of the intermediate transfer belt 51 and the photoconductive drums 31, as members related to image formation, between the contacting state and the separated state. The present exemplary embodiment may also be applied to mechanisms that switch the contact-separation states of other members, such as the photoconductive drums and an intermediate transfer drum, the photoconductive drums and the transfer rolls, as well as an intermediate transfer body and the transfer rolls.

### Second Exemplary Embodiment

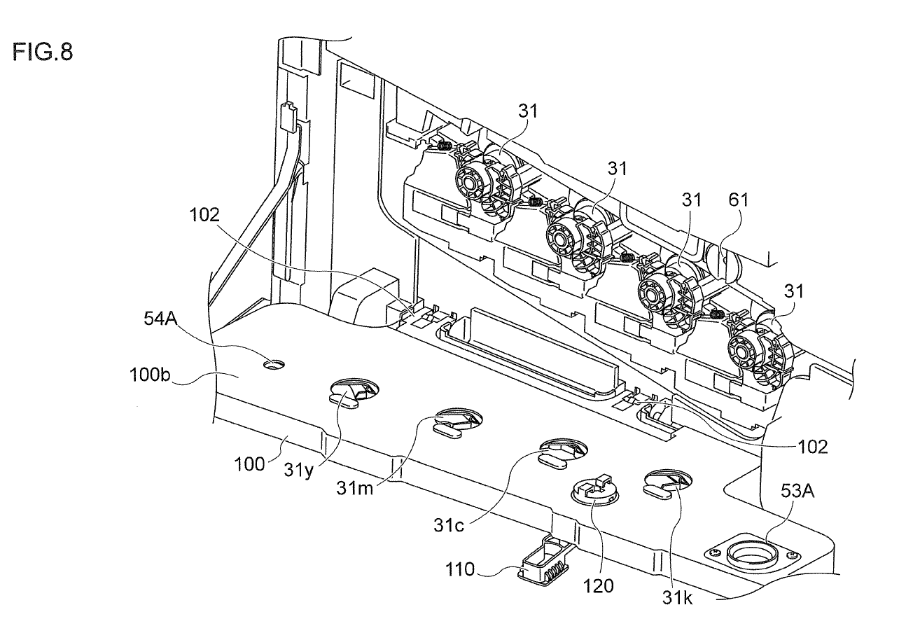

FIG. 8 is a view illustrating a positional relationship between a subframe-side coupling 120 and a lever 110 of the subframe 100 in a second exemplary embodiment, and corresponds to FIG. 4 in the first exemplary embodiment. Since a basic configuration of an image forming apparatus 1 of the present exemplary embodiment is the same as that in the first exemplary embodiment, a description thereof is omitted here.

As shown in FIG. 8, the lever 110 protrudes from the subframe 100 when the subframe 100 is opened. Specifically, a part of the lever 110 protrudes from the outline of the subframe 100. Accordingly, a user may seethe lever 110 while the subframe 100 is opened. This further facilitates an operation for the user to close the subframe 100.

It should be noted that the state in which the subframe 100 is closed is the same as that in the first exemplary embodiment shown in FIG. 6.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
an apparatus body that includes an image forming unit forming an image;
a switching mechanism that switches a state of members between a contacting state and a non-contacting state, the members related to image formation by the image forming unit in the apparatus body;
a covering unit that is supported in the apparatus body so as to be freely opened and closed, and that covers a part of the apparatus body when being closed; and
a connection unit that is provided to the covering unit, that is not connected to the switching mechanism when the covering unit is opened while being connected to the switching mechanism when the covering unit is closed, and that causes the switching mechanism to operate in conjunction with an operation by an operator any one of to open and to close the covering unit.

2. The image forming apparatus according to claim 1, further comprising an operation unit that is movably provided to the covering unit, and that is used by the operator any one of to open and to close the covering unit, wherein
the connection unit operates in conjunction with movement of the operation unit.

3. The image forming apparatus according to claim 2, wherein when the covering unit is opened, the operation unit is in a position different from a position when the covering unit is closed, and protrudes from an outline of the covering unit.

4. The image forming apparatus according to claim 2, further comprising a fixing mechanism that operates in conjunction with the movement of the operation unit, and that is engaged with the apparatus body and thereby fixes the covering unit so as to keep the covering unit closed.

5. An image forming apparatus comprising:
an apparatus body that includes an image forming unit forming an image;
a covering unit that is supported in the apparatus body so as to be freely opened and closed, and that covers a part of the apparatus body when being closed;
a first interlocking unit that is provided to the covering unit, and that operates in conjunction with an operation by an operator any one of to open and to close the covering unit;
a second interlocking unit that is provided to the apparatus body, that includes an engagement portion to be engaged with the first interlocking unit, and that operates in conjunction with an operation of the first interlocking unit in a state where the engagement portion is engaged with the first interlocking unit; and
a changing mechanism that is provided to the apparatus body, and that changes a state of members between a contacting state and a non-contacting state in accordance with an operation of the second interlocking unit, the members related to image formation by the image forming unit.

6. The image forming apparatus according to claim 5, wherein the engagement portion of the second interlocking unit is formed in a groove shape.

7. The image forming apparatus according to claim 6, wherein, when receiving the first interlocking unit, the engagement portion of the second interlocking unit extends in a direction toward a rotational axis of the covering unit about which the covering unit rotates to be opened and closed.

8. The image forming apparatus according to claim 5, wherein the first interlocking unit is provided so as to be capable of advancing and retracting with respect to the apparatus body, and moves, when being pressed by the second interlocking unit, in a direction of being pressed.
